(19) United States
(12) Patent Application Publication
(10) Pub. No.: US 2021/0141547 A1
(43) Pub. Date: May 13, 2021

(54) CONFIGURATION OF NON-VOLATILE DUAL IN-LINE MEMORY MODULES

(71) Applicant: HEWLETT-PACKARD DEVELOPMENT Companu, L.P., Spring, TX (US)

(72) Inventors: Diego Medaglia, Porto Alegre (BR); Taciano Perez, Porto Alegre (BR); Charles Staub, Porto Alegre (BR); Anellena Satos, Porto Alegre (BR); Kimon Berlin, Fort Collins, CO (US)

(21) Appl. No.: 16/605,179

(22) PCT Filed: Oct. 31, 2017
(86) PCT No.: PCT/US2017/059269

§ 371 Date: Oct. 14, 2019

(51) Int. Cl. G06F 3/06

(52) U.S. Cl. CPC G06F 3/0632; G06F 3/0623; G06F 3/0679; G06F 3/067; G06F 3/0622

(57) ABSTRACT

A system includes a server and a computer. The server stores a non-volatile dual in-line memory module (NVDIMM) configuration profile. The computer includes a plurality of NVDIMMs. The computer downloads the NVDIMM configuration profile from the server and applies the NVDIMM configuration profile to the plurality of NVDIMMs.

### BACKGROUND

Persistent memory is non-volatile memory that can be directly manipulated by a processor via load and store instructions and whose contents survive power cycles. Examples of non-volatile memory technologies include phase-change random access memory (PCRAM), spin-transfer torque magnetic random access memory (STT-MRAM), resistive random access memory (ReRAM), and memristor memory. Applications may exploit the ability to have direct access to persistent memory using memory mapping (also known as file mapping), resulting in leaner and faster applications.

### BRIEF DESCRIPTION OF THE DRAWINGS

FIG. 1 is a block diagram illustrating one example of a system for configuring non-volatile dual in-line memory modules (NVDIMMs).

FIG. 2 is a flow diagram illustrating one example of a method for creating a NVDIMM configuration file.

FIG. 3 is a flow diagram illustrating one example of a method for configuring NVDIMMs.

FIG. 4 is a block diagram illustrating another example of a system for configuring NVDIMMs.

FIG. 5 is a block diagram illustrating one example of a computer system for configuring NVDIMMs.

FIG. 6 is a flow diagram illustrating another example of a method for configuring NVDIMMs.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Non-volatile dual in-line memory modules (NVDIMMs) are a random-access memory for computers that retains its content when electrical power is removed. A set of NVDIMMs used within a computer may be configured in different ways to perform different functions on the computer. For example, a set of NVDIMMs used within a computer may be configured to 1) provide high-performance storage accessed at block granularity; 2) extend the computer memory capacity and ignore storage-related usages; or 3) be used as persistent memory, a combination of memory and storage semantics. NVDIMMs may be used in a stand-alone fashion or interleaved in sets, creating, in turn, different arrangements and connections to be managed. In addition, NVDIMMs may be self-encrypted, and each NVDIMM may have a singular passphrase for unlocking purposes, which makes management more complex. The information regarding the configuration of the NVDIMMs may be managed by the platform firmware, and stored in the label area of the NVDIMMs (i.e., a metadata area that includes the layout settings for a set of NVDIMMs). Manually setting these configurations for a large number of computers may be a tedious and error-prone task for administrators.

Accordingly, as disclosed herein, NVDIMMs of a computer may be configured via the platform firmware (e.g., Unified Extensible Firmware Interface (UEFI), Basic Input/Output System (BIOS)) of the computer or by a helper tool (e.g., application) using a NVDIMM configuration profile stored on a server. The NVDIMM configuration profile defines the properties for the NVDIMMs, such as the operation mode, interleaving, and encryption settings. The NVDIMM configuration profile may be created based on the properties of a current computer using the platform firmware or by using a helper tool. The computer to be configured downloads the NVDIMM configuration profile, authenticates the profile if necessary, verifies the profile is applicable to the computer, and applies the profile to the NVDIMMs of the computer.

FIG. 1 is a block diagram illustrating one example of a system 100 for configuring NVDIMMs. System 100 includes a server 102 and a plurality of computers 108₁ to 108_{M} where “M” is any suitable number of computers. Server 102 is communicatively coupled to each computer 108₁ to 108_{M} through a communication path 106. Communication path 106 may be part of a local area network (LAN), a wide area network (WAN), the Internet, or another suitable communication network.

Server 102 stores a NVDIMM configuration profile 104. NVDIMM configuration profile 104 may include an operation mode setting, an interleaving setting, an encryption setting, or another suitable setting for a set of NVDIMMs. NVDIMM configuration profile 104 is defined in a file, which may be in text format (e.g., Extensible Markup Language (XML), JavaScript Object Notation (JSON), text) or binary format. Each computer 108₁ to 108_{M} includes a plurality of NVDIMMs 110₁ to 110_{N}, where “N” is any suitable number of NVDIMMs. While each computer 108₁ to 108_{M} in FIG. 1 includes the same number “N” of NVDIMMs, in other examples each computer 108₁ to 108_{M} may include a different number of NVDIMMs. At least one of computers 108₁ to 108_{M} may download the NVDIMM configuration profile 104 from server 102 and apply the NVDIMM configuration profile to the corresponding plurality of NVDIMMs 110₁ to 110_{N} of the computer.

In one example, NVDIMM configuration profile 104 is encrypted or signed. In this example, after a computer 108₁ to 108_{M} downloads the NVDIMM configuration profile, the computer verifies the authenticity of the NVDIMM configuration profile using a public certificate of server 102 prior to applying the NVDIMM configuration profile to the corresponding plurality of NVDIMMs 110₁ to 110_{N} of the computer. In one example, at least one of computers 108₁ to 108_{M} may be used to create the NVDIMM configuration profile based on properties of the computer and upload the NVDIMM configuration profile to server 102 to provide NVDIMM configuration profile 104. In another example, at least one of computers 108₁ to 108_{M} may be used to create the NVDIMM configuration profile using an application (e.g., helper tool) and upload the NVDIMM configuration profile to server 102 to provide NVDIMM configuration profile 104.

FIG. 2 is a flow diagram illustrating one example of a method 200 for creating a NVDIMM configuration profile. In one example, method 200 is implemented by platform firmware 202 of a computer system and a server 212. Platform firmware 202 may include UEFI or BIOS. In another example, a helper tool may perform the functions of platform firmware 202 for creating a NVDIMM configuration profile. Server 212 may be a directory service (e.g., Lightweight Directory Access Protocol (LDAP) server, Active Directory server, etc.), a file server (e.g., File Transfer Protocol (FTP) server, Hypertext Transfer Protocol (HTTP) server), or another suitable server.

In one example, a NVDIMM configuration profile is created using an existing NVDIMM configuration of a computer as a template. At 204, a user enters the platform firmware user interface of an existing computer and configures the NVDIMMs by setting for example the operation mode, interleaving sets, encryption, etc. The user also configures the server address to be used in future interactions regarding the NVDIMM configuration profile. At 206, the user specifies a name for the NVDIMM configuration profile and saves the NVDIMM configuration profile based on the properties of the current computer. In another example, the user creates a NVDIMM configuration profile at 204 by editing a file containing the desired properties. The user may directly edit the file or may use an application (e.g., helper tool) to edit the file. In this example, at 206 the user specifies a name for the NVDIMM configuration profile and saves the NVDIMM configuration profile.

In either case, the NVDIMM configuration profile may be encrypted and/or signed. At 208, the user authenticates to server 212. In response to a successful authentication, at 210 the NVDIMM configuration profile is uploaded to server 212. Server 212 stores the NVDIMM configuration profile under the specified NVDIMM configuration profile name.

FIG. 3 is a flow diagram illustrating one example of a method 300 for configuring NVDIMMs. In one example, method 300 is implemented by platform firmware 302 of a computer system and a server 314. Platform firmware 302 may include UEFI or BIOS. In another example, a helper tool may perform the functions of platform firmware 302 for configuring NVDIMMs. Server 314 may be a directory service (e.g., LDAP server, Active Directory server, etc.), a file server (e.g., FTP server, HTTP server), or another suitable server.

At 304, a user turns on the computer to install the operating system. At 306, the firmware prompts for credentials to authenticate the user. At 308, the user authenticates to server 314. In response to a successful authentication and in response to an instruction to download the NVDIMM configuration profile, at 310 the firmware downloads the NVDIMM configuration profile from server 314. The computer may be instructed to download the NVDIMM configuration profile from server 314 in different ways. In one example, the user may select an option within the platform firmware user interface requesting the download. In another example, the platform firmware automatically connects to server 314 at boot time to check whether there is a NVDIMM configuration profile to be applied. In another example, an administrator may send the network path of the NVDIMM configuration profile through remote configuration interfaces to all computers to which the NVDIMM configuration profile is to be applied. At 312, the firmware applies the NVDIMM configuration profile to NVDIMMs of the computer.

The downloaded NVDIMM configuration profile may be signed and/or encrypted. In this case, the authenticity and integrity of the downloaded NVDIMM configuration profile are checked by the firmware using the server's public certificate prior to applying the NVDIMM configuration profile to the NVDIMMs of the computer.

The platform firmware may verify that the downloaded NVDIMM configuration profile is applicable to the physical disposition and capabilities of the NVDIMMs installed on the computer. In response to a successful verification, the NVDIMM configuration profile is applied. In response to an unsuccessful verification, the platform firmware may add an error to the firmware's log, warn the user about the problems found, and inform the user if a solution is available. The NVDIMM configuration profile may also include a fallback configuration which in the case of an unsuccessful verification may be applied to the NVDIMMs. The NVDIMM configuration profile is applied to the computer using a NVDIMM configuration interface (e.g., NVDIMM device driver).

FIG. 4 is a block diagram illustrating another example of a system 400 for configuring NVDIMMs. System 400 includes a computer 402 and a server 412. Server 412 stores a NVDIMM configuration profile 414. Computer 402 includes firmware 404 and a plurality of NVDIMMs 410₁ to 410_{N}. Firmware 404 includes NVDIMM configuration logic 406 and NVDIMM device driver 408.

In response to an instruction, NVDIMM configuration logic 406 downloads the saved NVDIMM configuration profile 414 from server 412. NVDIMM configuration logic 406 then parses/verifies the downloaded NVDIMM configuration profile and translates the profile into driver calls to NVDIMM device driver 408. NVDIMM device driver 408 translates the driver calls into device specific commands to configure NVDIMMs 410₁ to 410_{N} based on the NVDIMM configuration profile.

FIG. 5 is a block diagram illustrating one example of a computer system 500 for configuring NVDIMMs. Computer system 500 includes a processor 502, a machine-readable storage medium 506, and a plurality of NVDIMMs 514₁ to 514_{N}. Processor 502 is communicatively coupled to machine-readable storage medium 506 and NVDIMMs 514₁ to 514_{N} through a communication path 504. Although the following description refers to a single processor and a single machine-readable storage medium, the description may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 502 includes one or more central processing units (CPUs), microprocessors, and/or other suitable hardware devices for retrieval and execution of instructions stored in machine-readable storage medium 506. Processor 502 may fetch, decode, and execute instructions 508-512 to configure NVDIMMs 514₁ to 514_{N}. Processor 502 may fetch, decode, and execute instructions 508 to receive an instruction to download a NVDIMM configuration profile from a server. Processor 502 may fetch, decode, and execute instructions 510 to download the NVDIMM configuration profile from the server in response to the instruction. In one example, the NVDIMM configuration profile includes a file in a text format or a binary format. Processor 502 may fetch, decode, and execute instructions 512 to apply the NVDIMM configuration profile to the plurality of NVDIMMs 514₁ to 514_{N}.

In one example, processor 502 may fetch, decode and execute further instructions to authenticate the NVDIMM configuration profile downloaded from the server prior to applying the NVDIMM configuration profile to the plurality of NVDIMMs 514₁ to 514_{N}. Processor 502 may fetch, decode and execute further instructions to verify the NVDIMM configuration profile downloaded from the server is applicable to the plurality of NVDIMMs 514₁ to 514_{N} prior to applying the NVDIMM configuration profile to the plurality of NVDIMMs 514₁ to 514_{N}. In addition, processor 502 may fetch, decode and execute further instructions to apply the NVDIMM configuration profile to the plurality of NVDIMMs 514₁ to 514_{N} by configuring an operation mode setting, an interleaving setting, and an encryption setting of the plurality of NVDIMMs 514₁ to 514_{N}.

As an alternative or in addition to retrieving and executing instructions, processor 502 may include electronic circuits comprising a number of electronic components for performing the functionality of the instructions in machine-readable storage medium 506. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

Machine-readable storage medium 506 is a non-transitory storage medium and may be any suitable electronic, magnetic, optical, or other physical storage device that stores executable instructions. Thus, machine-readable storage medium 506 may be, for example, random access memory (RAM), an electrically-erasable programmable read-only memory (EEPROM), a storage drive, an optical disc, and the like. Machine-readable storage medium 506 may be disposed within computer system 500, as illustrated in FIG. 5. In this case, the executable instructions may be installed on computer system 500. Alternatively, machine-readable storage medium 506 may be a portable, external, or remote storage medium that allows computer system 500 to download the instructions from the portable/external/remote storage medium. In this case, the executable instructions may be part of an installation package.

FIG. 6 is a flow diagram illustrating another example of a method 600 for configuring NVDIMMs of a computer. At 602, method 600 includes creating a NVDIMM configuration profile. At 604, method 600 includes storing the NVDIMM configuration profile to a server. At 606, method 600 includes instructing a target computer to download the NVDIMM configuration profile from the server. In one example, instructing the target computer to download the NVDIMM configuration profile includes at least one of the following: selecting an option within a platform firmware user interface of the target computer; connecting a platform firmware of the target computer to the server at boot time to check whether a NVDIMM configuration profile is to be applied; and sending a network path of the NVDIMM configuration profile through a remote configuration interface to the target computer.

At 608, method 600 includes downloading the NVDIMM configuration profile from the server to the target computer in response to the instruction. At 610, method 600 includes determining whether the NVDIMM configuration profile is applicable to NVDIMMs installed on the target computer. At 612, method 600 includes applying the NVDIMM configuration profile to the NVDIMMs of the target computer in response to determining that the NVDIMM configuration profile is applicable to NVDIMMs installed on the target computer.

In one example, applying the NVDIMM configuration profile to the NVDIMMs of the target computer includes issuing commands to the NVDIMMs of the target computer via a NVDIMM device driver of the target computer. Further, method 600 may include informing a user of the target computer that the NVDIMM configuration profile cannot be applied in response to determining that the NVDIMM configuration profile is not applicable to NVDIMMs installed on the target computer. Method 600 may also include authenticating the NVDIMM configuration profile on the target computer.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a server storing a non-volatile dual in-line memory module (NVDIMM) configuration profile; and
a computer comprising a plurality of NVDIMMs, the computer to download the NVDIMM configuration profile from the server and apply the NVDIMM configuration profile to the plurality of NVDIMMs.

2. The system of claim 1, wherein the NVDIMM configuration profile is encrypted or signed, and
wherein the computer verifies the authenticity of the NVDIMM configuration profile using a public certificate of the server prior to applying the NVDIMM configuration profile to the plurality of NVDIMMs.

3. The system of claim 1, further comprising:
a further computer communicatively coupled to the server, the further computer to create the NVDIMM configuration profile based on properties of the further computer and upload the NVDIMM configuration profile to the server.

4. The system of claim 1, further comprising:
a further computer communicatively coupled to the server, the further computer to create the NVDIMM configuration profile using an application and upload the NVDIMM configuration profile to the server.

5. The system of claim 1, wherein the NVDIMM configuration profile comprises an operation mode setting, an interleaving setting, and an encryption setting.

6. A computer system comprising:
a plurality of non-volatile dual in-line memory modules (NVDIMMs);
a machine readable storage medium storing instructions; and
a processor to execute the instructions to:
receive an instruction to download a NVDIMM configuration profile from a server;
download the NVDIMM configuration profile from the server in response to the instruction; and
apply the NVDIMM configuration profile to the plurality of NVDIMMs.

7. The computer system of claim 6, wherein the processor executes the instructions to authenticate the NVDIMM configuration profile downloaded from the server prior to applying the NVDIMM configuration profile to the plurality of NVDIMMs.

8. The computer system of claim 6, wherein the processor executes the instructions to verify the NVDIMM configuration profile downloaded from the server is applicable to the plurality of NVDIMMs prior to applying the NVDIMM configuration profile to the plurality of NVDIMMs.

9. The computer system of claim 6, wherein the processor executes the instructions to apply the NVDIMM configuration profile to the plurality of NVDIMMs by configuring an operation mode setting, an interleaving setting, and an encryption setting of the plurality of NVDIMMs.

10. The computer system of claim 6, wherein the NVDIMM configuration profile comprises a file in a text format or a binary format.

11. A method for configuring non-volatile dual in-line memory modules (NVDIMMs) of a computer, the method comprising:
creating a NVDIMM configuration profile;
storing the NVDIMM configuration profile to a server;
instructing a target computer to download the NVDIMM configuration profile from the server;
downloading the NVDIMM configuration profile from the server to the target computer in response to the instruction;
determining whether the NVDIMM configuration profile is applicable to NVDIMMs installed on the target computer; and
applying the NVDIMM configuration profile to the NVDIMMs of the target computer in response to determining that the NVDIMM configuration profile is applicable to NVDIMMs installed on the target computer.

12. The method of claim 11, wherein instructing the target computer to download the NVDIMM configuration profile comprises at least one of the following:
selecting an option within a platform firmware user interface of the target computer;
connecting a platform firmware of the target computer to the server at boot time to check whether a NVDIMM configuration profile is to be applied; and
sending a network path of the NVDIMM configuration profile through a remote configuration interface to the target computer.

13. The method of claim 11, further comprising:
informing a user of the target computer that the NVDIMM configuration profile cannot be applied in response to determining that the NVDIMM configuration profile is not applicable to NVDIMMs installed on the target computer.

14. The method of claim 11, further comprising:
authenticating the NVDIMM configuration profile on the target computer.

15. The method of claim 11, wherein applying the NVDIMM configuration profile to the NVDIMMs of the target computer comprises issuing commands to the NVDIMMs of the target computer via a NVDIMM device driver of the target computer.
